(19) United States
(12) Patent Application Publication
(10) Pub. No.: US 2016/0041041 A1
(43) Pub. Date: Feb. 11, 2016

(54) TEMPERATURE SENSOR

(71) Applicant: NGK Spark Plug Co., LTD., Nagoya (JP)

(72) Inventors: Takuma NOMURA, Komaki (JP); So TOHARA, Nagoya (JP); Norimasa TAKAHASHI, Miyoshi (JP); Tatsuya SUZUKI, Bangkok (TH); Hiroko YOSHIDA, Komaki (JP); Toshinori NISHI, Niwa-gun (JP)

(73) Assignee: NGK SPARK PLUG CO., LTD., Nagoya (JP)

(21) Appl. No.: 14/820,901

(22) Filed: Aug. 7, 2015

(30) Foreign Application Priority Data
Aug. 8, 2014 (JP) 2014-162620

(51) Int. Cl. G01K 1/10; G01K 7/22

(52) U.S. Cl. CPC G01K 1/10; G01K 7/22

(57) ABSTRACT

A temperature sensor includes a sheath member having an insulative holding member which contains an oxygen supplying substance and is formed in such a manner that the oxygen supplying substance is exposed when viewed from an opening on the distal end side of a sheath tube. Since the insulative holding member releases oxygen from the distal end side of the sheath member, a decrease in oxygen concentration around a thermistor element can be suppressed. Thus, it is possible to suppress a change in the characteristics of the thermistor element due to reduction action, and to suppress decrease in temperature detection accuracy. Since the oxygen supplying substance is contained in the insulative holding member, compared with a configuration where a pellet is disposed on the distal end side of the thermistor element, delay in heat conduction is less likely to occur, and a decrease in temperature detection response can be suppressed.

This application claims the benefit of Japanese Patent Applications No. 2014-162620, filed Aug. 8, 2014, which is incorporated herein by reference in its entity.

### FIELD OF THE INVENTION

The present invention relates to temperature sensors using thermistor elements whose electrical characteristics change in accordance with change in temperature.

### BACKGROUND ART

Temperature sensors include a sensor that uses a thermistor element whose electrical characteristics change in accordance with change in temperature.

In such a temperature sensor, if an oxygen concentration around the thermistor element decreases, characteristics of the thermistor element may change due to reduction action, and temperature detection accuracy may decrease.

In contrast, a technology has been proposed in which, in a temperature sensor using a thermistor element, a pellet made of nickel oxide is disposed on the distal end side in the thermistor element, and oxygen is supplied from the pellet, thereby to suppress decrease in the oxygen concentration (Japanese Patent Application Laid-Open 2000-266609).

Moreover, another technology has been proposed in which, in a temperature sensor using a thermistor element, a cement member (filling member) containing an oxygen supplying substance is disposed around the thermistor element to supply oxygen, thereby to suppress decrease in the oxygen concentration (Japanese Patent Application Laid-Open 2005-055254).

In the temperature sensors employing these configurations, by suppressing decrease in the oxygen concentration around the thermistor element, it is possible to suppress change in characteristics of the thermistor element due to reduction action.

### Problems to be Solved by the Invention

However, in the temperature sensor equipped with a pellet, since the pellet is disposed in the heat conduction path extending from the outside on the distal end side of the temperature sensor to the thermistor element, delay in heat conduction may occur, and temperature detection response may decrease.

With respect to the temperature sensor in which the oxygen supplying substance is contained in the cement member, in the case of mass production in particular, the content of the oxygen supplying substance may not be enough, and temperature detection accuracy may decrease.

That is, in a large amount of the cement member in the production process during mass production, if unevenness has occurred in the dispersed state of the oxygen supplying substance, unevenness may occur in the content of the oxygen supplying substance contained in the cement member to be loaded into individual temperature sensors. In a temperature sensor filled with the cement member having an insufficient content of the oxygen supplying substance, the content of the oxygen supplying substance may not be enough to suppress decrease in the oxygen concentration around the thermistor element. Accordingly, temperature detection accuracy may decrease due to change in characteristics of the thermistor element caused by reduction action.

An object of the present invention is to provide a temperature sensor which suppresses decrease in temperature detection response, and which suppresses decrease in temperature detection accuracy.

### SUMMARY OF THE INVENTION

### Means for Solving the Problems

A temperature sensor according to a first aspect of the present invention includes a housing, a thermistor element, and a sheath member.

The housing is formed in a tubular shape whose distal end is closed.

The thermistor element is disposed inside the housing and electrical characteristics of the thermistor element change in accordance with change in temperature.

The sheath member has at least a distal end thereof disposed inside the housing. The sheath member includes a metal sheath tube, a core wire, and an insulation member, the core wire and the insulation member being disposed inside the metal sheath tube.

The metal sheath tube is formed in a tubular shape whose distal end and rear end are open. The core wire is formed from an electrically conductive material which is electrically connected to the thermistor element. The insulation member insulates between the core wire and the metal sheath tube.

The insulation member is filled with an insulating substance and an oxygen supplying substance inside the metal sheath tube. The oxygen supplying substance is a substance that supplies oxygen more efficiently than the insulating substance does. With respect to the insulation member, the insulating substance and the oxygen supplying substance are exposed when viewed from the opening on the distal end side of the metal sheath tube.

In the temperature sensor having this configuration, the insulation member containing the oxygen supplying substance releases oxygen from the distal end side of the metal sheath member, whereby it is possible to suppress decrease in oxygen concentration around the thermistor element, and to suppress the thermistor element from reacting with reducing gas and causing change in characteristics thereof. That is, in this temperature sensor, it is possible to suppress change in characteristics of the thermistor element due to reduction action, and to suppress decrease in temperature detection accuracy.

Since the oxygen supplying substance is contained in the insulation member, compared with a configuration where a pellet is disposed on the distal end side of the thermistor element, delay in heat conduction is less likely to occur, and thus, decrease in temperature detection response can be suppressed.

Therefore, according to the temperature sensor of the present invention, decrease in temperature detection response can be suppressed, and decrease in temperature detection accuracy can be suppressed.

In the temperature sensor described above, the insulation member may include a first insulation portion and a second insulation portion which has low electrical insulating property relative to that of the first insulation portion.

The first insulation portion is provided in such a manner that the core wire is electrically insulated from the metal sheath tube. The second insulation portion contains at least the oxygen supplying substance and is provided in such a manner that at least a part of the second insulation portion is exposed when viewed from the opening on the distal end side of the metal sheath tube.

By providing such an insulation member, it is possible to prevent the core wire and the metal sheath tube from being electrically short-circuited with each other (short-circuit abnormality).

Moreover, by the provision of the insulation member, the second insulation portion containing the oxygen supplying substance can release oxygen from the distal end side of the sheath member, and it is possible to suppress the thermistor element from reacting with reducing gas and causing change in characteristics thereof.

In the temperature sensor including the first insulation portion and the second insulation portion described above, the first insulation portion may not contain the oxygen supplying substance.

Since the first insulation portion does not contain the oxygen supplying substance, formation of an electric conductive path by the oxygen supplying substance can be prevented, and electrical insulating property at the first insulation portion can be ensured. Thus, it is possible to prevent occurrence of electrical short-circuit abnormality between the sheath core wire and the metal sheath tube. Accordingly, it is possible to prevent inability of temperature detection caused by the short-circuit abnormality between the sheath core wire and the metal sheath tube.

The temperature sensor including the first insulation portion and the second insulation portion described above may include a plurality of the core wires in the sheath member, and the second insulation portion may be disposed in such a manner that the second insulation portion does not provide electrical connection between the plurality of the core wires.

By employing this configuration, it is possible to prevent formation of an electric conductive path by the second insulation portion between the plurality of the core wires, and thus, to prevent short-circuit abnormality between the plurality of the core wires.

It should be noted that “the second insulation portion does not provide electrical connection between the plurality of the core wires” means that, for example, the second insulation portion is in contact with none of the plurality of the core wires, that the second insulation portion is in contact with only one of the plurality of the core wires, and that the second insulation portion is in contact with the metal sheath tube only.

In the temperature sensor including the first insulation portion and the second insulation portion described above, the first insulation portion may be configured to surround the core wire in a cross section perpendicular to the longitudinal direction of the sheath member, and the second insulation portion may be configured to surround the first insulation portion in a cross section perpendicular to the longitudinal direction of the sheath member.

By employing this configuration, it is possible to maintain electrical insulation between the core wire and the metal sheath tube by means of the first insulation portion, and since the second insulation portion releases oxygen, it is possible to suppress the thermistor element from reacting with reducing gas and causing change in characteristics thereof.

In the temperature sensor described above, the insulation member may contain the insulating substance as a main component, and the oxygen supplying substance may be dispersed in the insulating substance.

Accordingly, the insulating substance being the main body of the insulation member suppresses electric conduction between the core wire and the metal sheath tube, whereby short-circuit abnormality in the temperature sensor can be prevented. In addition, since the oxygen supplying substance supplies oxygen, it is possible to suppress change in characteristics of the thermistor element, and to suppress decrease in temperature detection accuracy.

### Effects of the Invention

According to the temperature sensor of the present invention, decrease in temperature detection response can be suppressed and decrease in temperature detection accuracy can be suppressed.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a partially cutout cross-sectional view showing the structure of a temperature sensor.

FIG. 2 is an explanatory view showing the appearance of a sheath member on the distal end side thereof.

FIG. 3 is an explanatory view showing the appearance of a second sheath member on the distal end side thereof.

FIG. 4 is an explanatory view showing the appearance of a third sheath member on the distal end side thereof.

FIG. 5 is an explanatory view showing the appearance of a fourth sheath member on the distal end side thereof.

### DETAILED DESCRIPTION OF THE INVENTION

Hereinafter, embodiments to which the present invention is applied will be described with reference to the drawings.

It should be noted that the present invention is not limited to the embodiments below to any extent, and can take various forms as long as the embodiment belongs to the technological scope of the present invention.

### 1. First Embodiment

[1-1. Overall Configuration]

As a first embodiment, a temperature sensor 1 will be described which is used in detection of the temperature of exhaust gas from an internal combustion engine such as an automobile.

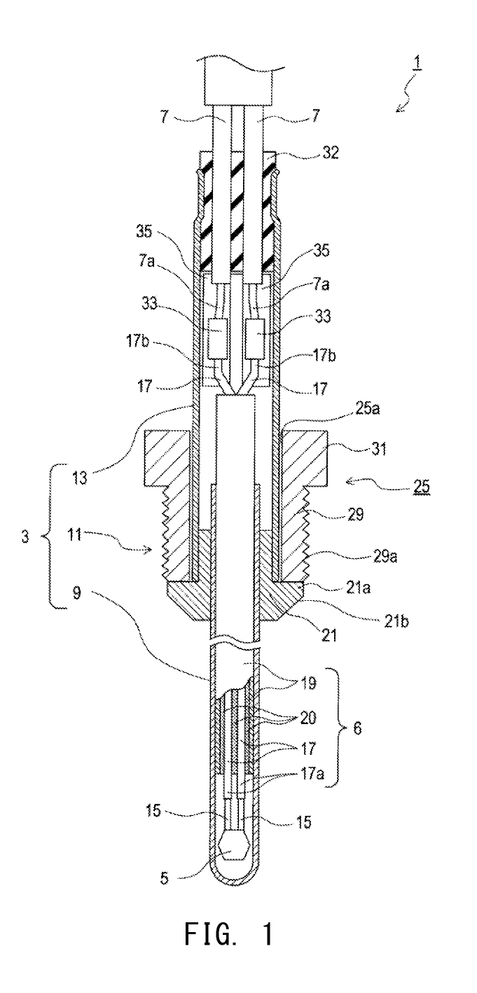

FIG. 1 is a partially cutout cross-sectional view showing the structure of the temperature sensor 1. In FIG. 1, of the longitudinal directions (up-down directions in the drawing) of the temperature sensor 1, the lower side in the drawing is the distal end side of the temperature sensor 1, and the upper side of the drawing is the proximal end side of the temperature sensor 1.

As shown in FIG. 1, the temperature sensor 1 includes a housing 3, a thermistor element 5, a sheath member 6, and a pair of lead wires 7.

The housing 3 includes a first housing 9, an intermediate member 11, and a second housing 13.

The first housing 9 is formed in a cylindrical shape whose distal end is closed, and the thermistor element 5 is disposed inside the first housing 9 on the distal end side. The second housing 13 is formed in a cylindrical shape having a diameter larger than that of the first housing 9.

The intermediate member 11 includes: a tubular member 21 which prevents leak of exhaust gas whose temperature is to be detected; and a screw member 25 which fixes the temperature sensor 1 to an exhaust pipe (not shown). It should be noted that the screw member 25 corresponds to a so-called fastening nut.

The tubular member 21 is fixed to the first housing 9, on the proximal end side, and the distal end of the second housing 13 is fixed to the outer periphery of the rear end of the tubular member 21. The tubular member 21 has a protrusion 21a which protrudes in the radial direction, and a tapered surface 21b is formed at the distal end of the protrusion 21a.

The first housing 9 and the second housing 13 are each connected to the tubular member 21 of the intermediate member 11, and are coaxially disposed with a part of the first housing 9 and a part of the second housing 13 overlapping each other. The first housing 9 is connected, on the proximal end side thereof, to the inside of the tubular member 21. The second housing 13 is connected, on the distal end side thereof, to the outside of the tubular member 21.

The screw member 25 has a center hole 25a about its axis, and the inner diameter of the center hole 25a is set so as to allow the second housing 13 to be inserted through the center hole 25a. The screw member 25 is rotatably disposed on the outer periphery of the second housing 13 which is fixed to the rear end of the tubular member 21.

The screw member 25 includes a screw part 29 having a male screw 29a formed on the outer peripheral surface thereof, and a hexagon nut part 31 formed on the screw part 29 on the proximal end side thereof. The screw member 25 is a member for fixing the temperature sensor 1 to the exhaust pipe, with the male screw 29a being screwed into a boss (not shown) provided in the exhaust pipe.

The thermistor element 5 includes an electrically conductive oxide sintered body, and is a thermosensitive device whose electrical characteristics change in accordance with change in temperature. The thermistor element 5 includes a pair of electrodes 15. The pair of electrodes 15 are provided so as to output an electrical signal which changes in accordance with the electrical characteristics of the thermistor element 5.

The sheath member 6 includes a pair of core wires 17, a sheath tube 19, and an insulative holding member 20.

The pair of core wires 17 are formed from an electrically conductive material, and their distal end portions 17a are connected to the pair of electrodes 15, respectively.

The sheath tube 19 is formed from a metal material and is a tubular member whose distal end and rear end are open. The pair of core wires 17 are inserted in the sheath tube 19.

The insulative holding member 20 is formed from a mixed material having an insulating material (silicon oxide (SiO₂) in the present embodiment) as the main body with an oxygen supplying substance (cerium oxide (CeO₂) in the present embodiment) added thereto. The oxygen supplying substance is formed from a substance that supplies oxygen more easily than the insulating material does. The oxygen supplying substance is dispersed in the insulating material. The insulative holding member 20 electrically insulates each of the pair of core wires 17 and the sheath tube 19, and is disposed inside the sheath tube 19 in a state of holding the pair of core wires 17.

The sheath member 6 is disposed in a state where a portion thereof on the distal end side is inserted inside the first housing 9 and a portion thereof on the proximal end side protrudes from the opening on the proximal end side of the first housing 9.

With respect to the pair of lead wires 7, the distal end portions 7a thereof are joined through caulking by caulking terminals 33 to the rear end portions 17b of the pair of core wires 17, respectively. Accordingly, the pair of lead wires 7 form a signal path for taking out an electrical signal which changes in accordance with the electrical characteristics of the thermistor element 5, to the outside of the housing 3.

It should be noted that insulation tubes 35 which respectively cover the rear end portions 17b of the core wires 17, the distal end portions 7a of the lead wires 7, and the caulking terminals 33 are provided. The insulation tubes 35 ensure electrical insulation between the pair of core wires 17, between the pair of lead wires 7, and between the two caulking terminals 33.

In addition, a grommet 32 made of heat-resisting rubber is fixed through caulking to the second housing 13 on the proximal end side thereof. The pair of lead wires 7 pass through the grommet 32 and protrude outside the proximal end of the second housing 13.

[1-2. Sheath Member]

Next, the sheath member 6 will be described in detail.

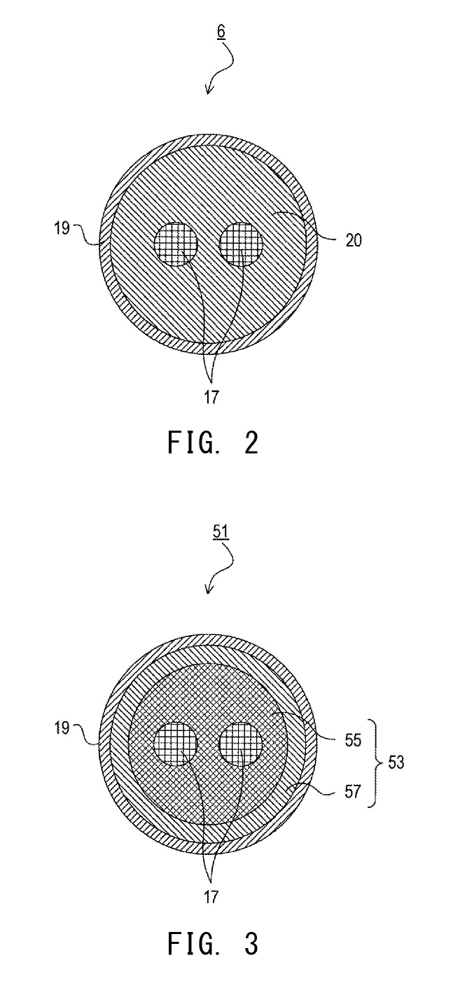

FIG. 2 is an explanatory view showing the appearance of the sheath member 6 on the distal end side.

As shown in FIG. 2, the sheath member 6 is formed such that the pair of core wires 17 and the insulative holding member 20 are disposed inside the sheath tube 19.

In addition, the insulative holding member 20 is disposed in a state of being exposed to the outside when viewed from the opening on the distal end side of the sheath tube 19.

As described above, the insulative holding member 20 is formed from the mixed material having the insulating material (silicon oxide: SiO₂) as the main body with the oxygen supplying substance (cerium oxide: CeO₂) added thereto. The oxygen supplying substance is formed from a substance that supplies oxygen more easily than the insulating material does. In addition, the insulative holding member 20 is formed in a state where the oxygen supplying substance is exposed to the outside when viewed from the opening on the distal end side of the sheath tube 19.

The sheath member 6 including the insulative holding member 20 as above releases oxygen from the distal end side of the sheath member 6, thereby being able to suppress decrease in the oxygen concentration around the thermistor element 5. As a result, it is possible to suppress the thermistor element 5 from reacting with reducing gas and causing change in characteristics thereof.

In addition, since the insulative holding member 20 is formed from the insulating material which is used as the main body, the insulating material can suppress electric conduction between the pair of core wires 17.

[1-3. Effect]

As described above, the temperature sensor 1 according to the present embodiment includes the sheath member 6 which has the insulative holding member 20 containing the oxygen supplying substance.

The insulative holding member 20 of the sheath member 6 contains the oxygen supplying substance, and is formed in a state where the oxygen supplying substance is exposed to the outside when viewed from the opening on the distal end side of the sheath tube 19.

In the temperature sensor 1 having such a configuration, the insulative holding member 20 containing the oxygen supplying substance releases oxygen from the distal end side of the sheath member 6, whereby it is possible to suppress decrease in the oxygen concentration around the thermistor element 5, and thus, it is possible to suppress the thermistor element 5 from reacting with reducing gas and causing change in characteristics thereof. That is, in the temperature sensor 1, it is possible to suppress change in characteristics of the thermistor element 5 due to reduction action, and it is possible to suppress decrease in temperature detection accuracy.

Furthermore, since the oxygen supplying substance is contained in the insulative holding member 20 of the sheath member 6, compared with a configuration where a pellet is disposed on the distal end side of the thermistor element 5, delay in heat conduction is less likely to occur, and thus, decrease in temperature detection response can be suppressed.

Therefore, according to the temperature sensor 1, it is possible to suppress decrease in temperature detection response, and to suppress decrease in temperature detection accuracy.

[1-4. Correspondence to Claims]

Now, correspondence between words in the present embodiment and those in claims will be explained.

The temperature sensor 1 corresponds to one example of the temperature sensor, the first housing 9 corresponds to one example of the housing, the thermistor element 5 corresponds to one example of the thermistor element, the sheath member 6 corresponds to one example of the sheath member, the sheath tube 19 corresponds to one example of the metal sheath tube, the core wire 17 corresponds to one example of the core wire, and the insulative holding member 20 corresponds to one example of the insulation member.

### 2. Second Embodiment

Next as a second embodiment, a second temperature sensor in which the insulation member of the sheath member includes a first insulation portion and a second insulation portion will be described.

It should be noted that, in the second temperature sensor, the configuration of the sheath member is different from that in the temperature sensor 1 of the first embodiment and the other configurations are the same as those in the temperature sensor 1. Thus, the sheath member will be mainly described. The configurations that are the same as those in the temperature sensor 1 are denoted by the same reference numerals to be described.

FIG. 3 is an explanatory view showing the appearance, on the distal end side, of a second sheath member 51 provided in the second temperature sensor.

The second sheath member 51 includes the pair of core wires 17, the sheath tube 19, and a second insulative holding member 53.

The second insulative holding member 53 is disposed inside the sheath tube 19 in a state where the second insulative holding member 53 electrically insulates each of the pair of core wires 17 and the sheath tube 19 and holds the pair of core wires 17.

The second insulative holding member 53 includes a first insulation portion 55 and a second insulation portion 57.

The first insulation portion 55 is formed from an insulating material (silicon oxide (SiO₂) in the present embodiment). The first insulation portion 55 is formed in a state of surrounding the pair of core wires 17 in a cross section perpendicular to the longitudinal direction of the second sheath member 51. That is, the first insulation portion 55 is provided in a state where the pair of core wires 17 are electrically insulated from each other by the first insulation portion 55.

The second insulation portion 57 is formed from an oxygen supplying substance (cerium oxide (CeO₂)) in the present embodiment). The second insulation portion 57 is formed in a state of surrounding the first insulation portion 55 in a cross section perpendicular to the longitudinal direction of the second sheath member 51. Further, the second insulation portion 57 is disposed in a state of continuously extending from the opening on the distal end side of the sheath tube 19 to the opening on the rear end side thereof. The second insulation portion 57 is provided in a state of being exposed to the outside when viewed from the opening on the distal end side of the sheath tube 19 at least.

That is, in the second insulative holding member 53, the first insulation portion 55 is formed from a material having high electrical insulating property relative to that of the second insulation portion 57.

By providing the second insulative holding member 53 as described above, it is possible to prevent the pair of core wires 17 from being electrically short-circuited with each other (short-circuit abnormality).

Regarding the electrical insulating properties of the first insulation portion 55 and the second insulation portion 57, which of the first insulation portion 55 and the second insulation portion 57 has higher electrical insulating property can be determined by confirming the physical property values of the materials forming these, for example.

By the provision of the second insulative holding member 53 as above, the second insulation portion 57 containing the oxygen supplying substance can release oxygen from the distal end side of the second sheath member 51, and thus, it is possible to suppress the thermistor element 5 from reacting with reducing gas and causing change in characteristics thereof.

Therefore, similarly to the temperature sensor 1, the second temperature sensor including the second insulative holding member 53 can suppress decrease in temperature detection response and can suppress decrease in temperature detection accuracy.

Now, correspondence between words in the present embodiment and those in claims will be explained.

The second sheath member 51 corresponds to one example of the sheath member, the second insulative holding member 53 corresponds to one example of the insulation member, the first insulation portion 55 corresponds to one example of the first insulation portion, and the second insulation portion 57 corresponds to one example of the second insulation portion.

### 3. Third Embodiment

Next, as a third embodiment, a third temperature sensor including a sheath member in which the second insulation portion containing an oxygen supplying substance is divided and disposed in two places will be described.

It should be noted that, in the third temperature sensor, the configuration of the sheath member is different from that in the temperature sensor 1 of the first embodiment and the other configurations are the same as those in the temperature sensor 1. Thus, the sheath member will be mainly described. The configurations that are the same as those in the temperature sensor 1 are denoted by the same reference numerals to be described.

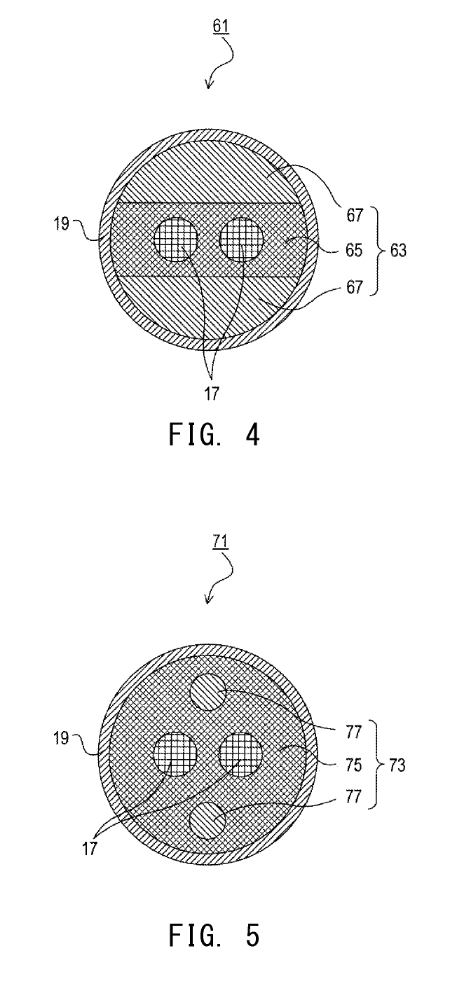

FIG. 4 is an explanatory view showing the appearance, on the distal end side, of a third sheath member 61 provided in the third temperature sensor.

The third sheath member 61 includes the pair of core wires 17, the sheath tube 19, and a third insulative holding member 63.

The third insulative holding member 63 is disposed inside the sheath tube 19 in a state where the third insulative holding member 63 electrically insulates each of the pair of core wires 17 and the sheath tube 19 and holds the pair of core wires 17.

The third insulative holding member 63 includes a first insulation portion 65 and a second insulation portion 67.

The first insulation portion 65 is formed from an insulating material (silicon oxide (SiO₂) in the present embodiment). The first insulation portion 65 is formed in a state where, in a cross section perpendicular to the longitudinal direction of the third sheath member 61, the first insulation portion 65 surrounds the pair of core wires 17 and at least a part of the first insulation portion 65 is in contact with the sheath tube 19. That is, the first insulation portion 65 is provided in a state where the pair of core wires 17 are electrically insulated from each other by the first insulation portion 65.

The second insulation portion 67 is formed from an oxygen supplying substance (cerium oxide (CeO₂) in the present embodiment). The second insulation portion 67 is formed in a state where, in a cross section perpendicular to the longitudinal direction of the third sheath member 61, the second insulation portion 67 is formed, divided in two places so as to sandwich the first insulation portion 55 therebetween, and at least a part of the second insulation portion 67 is in contact with the sheath tube 19. Further, the second insulation portion 67 is disposed in a state of continuously extending from the opening on the distal end side of the sheath tube 19 to the opening on the rear end side thereof. The second insulation portion 67 is provided in a state of being exposed to the outside when viewed from the opening on the distal end side of the sheath tube 19 at least.

That is, in the third insulative holding member 63, the first insulation portion 65 is formed from a material having high electrical insulating property relative to that of the second insulation portion 67.

By providing the third insulative holding member 63 as above, it is possible to prevent the pair of core wires 17 from being electrically short-circuited with each other (short-circuit abnormality).

Moreover, by the provision of the third insulative holding member 63 as above, the second insulation portion 67 containing the oxygen supplying substance can release oxygen from the distal end side of the third sheath member 61, and it is possible to suppress the thermistor element 5 from reacting with reducing gas and causing change in characteristics thereof.

Therefore, similarly to the temperature sensor 1, the third temperature sensor including the third insulative holding member 63 can suppress decrease in temperature detection response and can suppress decrease in temperature detection accuracy.

Now, correspondence between words in the present embodiment and those in claims will be explained.

The third sheath member 61 corresponds to one example of the sheath member, the third insulative holding member 63 corresponds to one example of the insulation member, the first insulation portion 65 corresponds to one example of the first insulation portion, and the second insulation portion 67 corresponds to one example of the second insulation portion.

### 4. Fourth Embodiment

Next, as a fourth embodiment, a fourth temperature sensor including a sheath member in which the second insulation portion containing an oxygen supplying substance is divided and disposed in two places will be described.

It should be noted that, in the fourth temperature sensor, the configuration of the sheath member is different from that in the temperature sensor 1 of the first embodiment and the other configurations are the same as those in the temperature sensor 1. Thus, the sheath member will be mainly described. The configurations that are the same as those in the temperature sensor 1 are denoted by the same reference numerals to be described.

FIG. 5 is an explanatory view showing the appearance, on the distal end side, of a fourth sheath member 71 provided in the fourth temperature sensor.

The fourth sheath member 71 includes the pair of core wires 17, the sheath tube 19, and a fourth insulative holding member 73.

The fourth insulative holding member 73 is disposed inside the sheath tube 19 in a state where the fourth insulative holding member 73 electrically insulates each of the pair of core wires 17 and the sheath tube 19 and holds the pair of core wires 17.

The fourth insulative holding member 73 includes a first insulation portion 75 and a second insulation portion 77.

The first insulation portion 75 is formed from an insulating material (silicon oxide (SiO₂) in the present embodiment). The first insulation portion 75 is formed in a state where, in a cross section perpendicular to the longitudinal direction of the fourth sheath member 71, the first insulation portion 75 surrounds the pair of core wires 17 and the outer periphery of the first insulation portion 75 is in contact with the sheath tube 19. That is, the first insulation portion 75 is provided in a state where the pair of core wires 17 are electrically insulated from each other by the first insulation portion 75.

The second insulation portion 77 is formed from an oxygen supplying substance (cerium oxide (CeO₂) in the present embodiment). The second insulation portion 77 is formed, divided in two places, in a state of being surrounded by the first insulation portion 75 in a cross section perpendicular to the longitudinal direction of the fourth sheath member 71. Further, the second insulation portion 77 is disposed in a state of continuously extending from the opening on the distal end side of the sheath tube 19 to the opening on the rear end side thereof. The second insulation portion 77 is provided in a state of being exposed to the outside when viewed from the opening on the distal end side of the sheath tube 19 at least.

That is, in the fourth insulative holding member 73, the first insulation portion 75 is formed from a material having high electrical insulating property relative to that of the second insulation portion 77.

By providing the fourth insulative holding member 73 as above, it is possible to prevent the pair of core wires 17 from being electrically short-circuited with each other (short-circuit abnormality).

Moreover, by the provision of the fourth insulative holding member 73 as above, the second insulation portion 77 containing the oxygen supplying substance can release oxygen from the distal end side of the fourth sheath member 71, and it is possible to suppress the thermistor element 5 from reacting with reducing gas and causing change in characteristics thereof.

Therefore, similarly to the temperature sensor 1, the fourth temperature sensor including the fourth insulative holding member 73 can suppress decrease in temperature detection response and can suppress decrease in temperature detection accuracy.

Now, correspondence between words in the present embodiment and those in claims will be explained.

The fourth sheath member 71 corresponds to one example of the sheath member, the fourth insulative holding member 73 corresponds to one example of the insulation member, the first insulation portion 75 corresponds to one example of the first insulation portion, and the second insulation portion 77 corresponds to one example of the second insulation portion.

### 5. Other Embodiments

Embodiments of the present invention have been described. The present invention is not limited to the above embodiments and may be embodied in various other forms without departing from the gist of the present invention.

For example, the configuration of the sheath member is not limited to those described above. The sheath member can employ any form as long as electrical insulation between the core wire and the metal sheath tube is ensured and the oxygen supplying substance is exposed on the distal end side.

Moreover, the configuration in which the insulation member of the sheath member includes the first insulation portion and the second insulation portion is not limited to those described above. For example, the configuration of the second insulation portion is not limited to the configuration where the second insulation portion is disposed in one place or two places in a cross section perpendicular to the longitudinal direction of the sheath member. The second insulation portion may be divided and disposed in three or more places.

The first insulation portion is not limited to those formed only from an insulating material. As long as the first insulation portion is formed to have high insulating property relative to that of the second insulation portion, the first insulation portion may contain an oxygen supplying substance.

The second insulation portion is not limited to those formed only from an oxygen supplying substance. As long as the second insulation portion can supply oxygen from the distal end side of the sheath member at least, the second insulation portion may contain an insulating material.

The insulating material in the insulation member is not limited to silicon oxide, and for example, magnesia (MgO), alumina (Al₂O₃), or the like may be used.

The oxygen supplying substance in the insulation member is not limited to cerium oxide, and may be at least one of NiO, CoO, WO₃, CuO, Ga₂O₃, SnO₂, Fe₂O₃, Ta₂O₅, and ZrO₂, for example.

### DESCRIPTION OF REFERENCE NUMERALS

1: temperature sensor; 3: housing; 5: thermistor element; 6: sheath member; 9: first housing; 11: intermediate member; 13: second housing; 15: electrode; 17: core wire; 19: sheath tube; 20: insulative holding member; 51: second sheath member; 53: second insulative holding member; 55: first insulation portion; 57: second insulation portion; 61: third sheath member; 63: third insulative holding member; 65: first insulation portion; 67: second insulation portion; 71: fourth sheath member; 73: fourth insulative holding member; 75: first insulation portion; 77: second insulation portion.

1. A temperature sensor comprising:
a housing having a tubular shape whose distal end is closed;
a thermistor element which is disposed inside the housing and whose electrical characteristics change in accordance with change in temperature; and
a sheath member having at least a distal end thereof disposed inside the housing, and including: a metal sheath tube whose distal end and rear end are open; at least one electrically conductive core wire electrically connected to the thermistor element; and an insulation member insulating between the core wire and the metal sheath tube, the core wire and the insulation member being disposed inside the metal sheath tube, wherein
the insulation member is filled with, an insulating substance and an oxygen supplying substance that supplies oxygen more easily efficiently than the insulating substance does, and
the insulating substance and the oxygen supplying substance are exposed when viewed from an opening on the distal end side of the metal sheath tube.

2. The temperature sensor according to claim 1, wherein
the insulation member includes a first insulation portion and a second insulation portion which has a low electrical insulating property relative to that of the first insulation portion,
the first insulation portion is provided in such a manner that the core wire is electrically insulated from the metal sheath tube, and
the second insulation portion contains at least the oxygen supplying substance and is provided in such a manner that at least a part of the second insulation portion is exposed when viewed from the opening on the distal end side of the metal sheath tube.

3. The temperature sensor according to claim 2, wherein
the first insulation portion does not contain the oxygen supplying substance.

4. The temperature sensor according to claim 2, wherein
the sheath member includes a plurality of the core wires, and
the second insulation portion is disposed in such a manner that the second insulation portion does not provide electrical connection between the plurality of the core wires.

5. The temperature sensor according to claim 2, wherein
the first insulation portion is configured to surround the core wire in a cross section perpendicular to a longitudinal direction of the sheath member, and
the second insulation portion is configured to surround the first insulation portion in the cross section.

6. The temperature sensor according to claim 1, wherein
the insulation member contains the insulating substance as a main component, and
the oxygen supplying substance is dispersed in the insulating substance.

7. 4. The temperature sensor according to claim 3, wherein
the sheath member includes a plurality of the core wires, and
the second insulation portion is disposed in such a manner that the second insulation portion does not provide electrical connection between the plurality of the core wires.

8. The temperature sensor according to claim 3, wherein
the first insulation portion is configured to surround the core wire in a cross section perpendicular to a longitudinal direction of the sheath member, and
the second insulation portion is configured to surround the first insulation portion in the cross section.

9. The temperature sensor according to claim 4, wherein
the first insulation portion is configured to surround the core wire in a cross section perpendicular to a longitudinal direction of the sheath member, and
the second insulation portion is configured to surround the first insulation portion in the cross section.
